(19) United States
(12) Patent Application Publication
(10) Pub. No.: US 2007/0062649 A1
(43) Pub. Date: Mar. 22, 2007

(54) Laminating machine having a cutter assembly

(76) Inventor: Janice New, Taipei City (TW)

Correspondence Address: BROWDY AND NEIMARK, P.L.L.C.;624 NINTH STREET, NW, SUITE 300, WASHINGTON, DC, 20001-5303, US

(21) Appl. No.: 11/274,262

(22) Filed: Nov. 16, 2005

(30) Foreign Application Priority Data
Sep. 20, 2005 (TW) 200520105355.3

(51) Int. Cl. B32B 38/04; B32B 37/00

(52) U.S. Cl. 156/510; 156/523

(57) ABSTRACT

A laminating machine includes a housing, a rail mounted on the housing and defining with the housing a narrow elongated gap for the insertion of the laminated object, and a cutter assembly coupled to and movable along the rail for cutting the laminated object being inserted into the narrow elongated gap.

### BACKGROUND OF THE INVENTION

1. Field of the Invention

The present invention relates to a laminating machine and more particularly, to such a laminating machine that has a cutter assembly for cutting the edge of the laminated object.

2. Description of the Related Art

A laminating machine for laminating an object, for example, a photo with a laminating film generally comprises a housing. The housing has an inlet and an outlet respectively disposed at the front and back sides for the passing of the object to be laminated, and an inside accommodating chamber for accommodating a feed roller, a sheet-transferring roller, a heat sealing member and other related parts. When an object is inserted into the inlet of the housing, the feed roller and the sheet-transferring roller carry the object out of the housing through the outlet, and at the same time the heat sealing member seals the inserted object with the laminating film.

Because the user may laminate different objects having different sizes with the same laminating film, the laminated objects may have to be properly cut. In this case, a cutting device shall be used.

### SUMMARY OF THE INVENTION

The present invention has been accomplished under the circumstances in view. It is one objective of the present invention to provide a laminating machine, which is equipped with a cutter assembly for cutting the edge of the laminated object.

It is another objective of the present invention to provide a laminating machine with a cutter assembly, which is easy and convenient to operate.

To achieve the above-mentioned objectives, the laminating machine provided by the present invention comprises a housing, a rail mounted on the housing and defining with the housing a narrow elongated gap for the insertion of the laminated object, and a cutter assembly coupled to and movable along the rail for cutting the laminated object being inserted into the narrow elongated gap.

The housing has preferably two top recessed bearing portions for the positioning of the rail. The rail has a longitudinal sliding slot. The cutter assembly comprises a casing, which is composed of a carrier block coupled to and movable along the longitudinal sliding slot of the rail and a cover covering the carrier block, a first cutter mounted in a first chamber in the carrier block, a second cutter mounted in the second chamber in the carrier block, and an operating member for selectively moving the first cutter and the second cutter out of the carrier block into the narrow elongated gap for cutting the inserted laminated object.

The housing has preferably a sliding groove in the top side corresponding to the sliding slot of the rail for receiving the first cutter or the second cutter that is moved out of the carrier block by the operating member.

### BRIEF DESCRIPTION OF THE DRAWINGS

FIG. 1 is a perspective view of a laminating machine according to the present invention.

FIG. 2 is an exploded view of the cutter assembly of the laminating machine according to the present invention.

FIG. 3 is a sectional assembly view of the cutter assembly for the laminating machine according to the present invention.

FIG. 4 is a sectional view of a part of the present invention, showing the position of the cutter blade of the first cutter after shifting of the operating member of the cutter assembly to the first position.

FIG. 5 is a sectional view of a part of the present invention, showing the position of the roller cutter blade of the second cutter after shifting of the operating member of the cutter assembly to the first position.

FIG. 6 is a sectional view of a part of the present invention, showing the position of the cutter blade of the first cutter after shifting of the operating member of the cutter assembly to the second position.

FIG. 7 is a sectional view of a part of the present invention, showing the position of the roller cutter blade of the second cutter after shifting of the operating member of the cutter assembly to the second position.

### DETAILED DESCRIPTION OF THE INVENTION

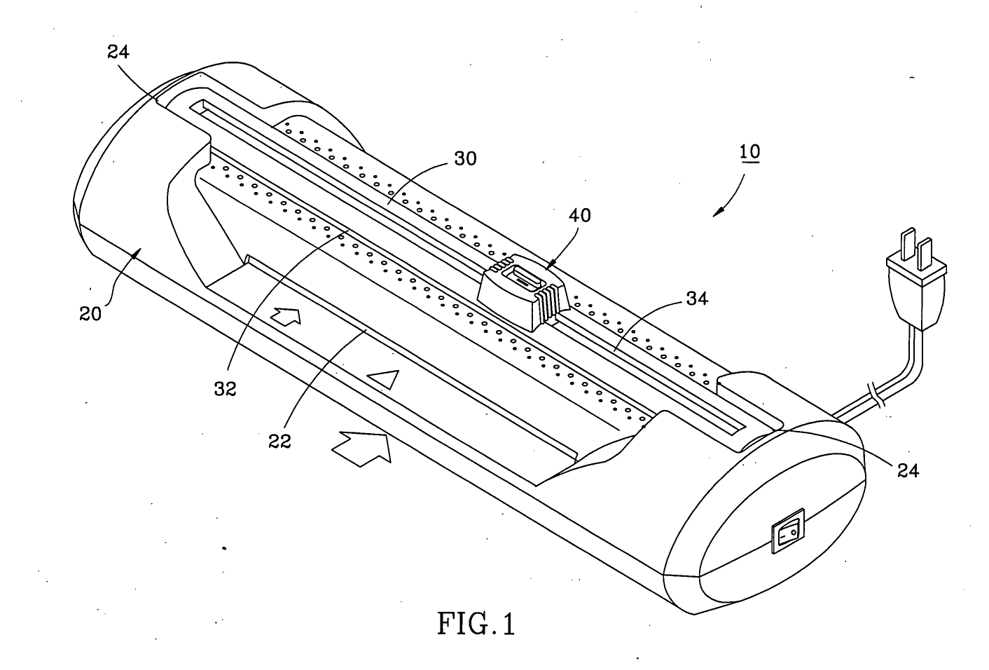

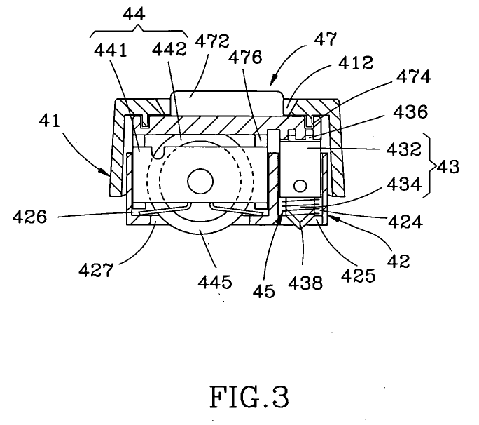

Referring to FIGS. 1-4, a laminating machine 10 in accordance with the present invention is shown comprising a housing 20, a rail 30, and a cutter assembly 40.

The housing 20 has an inlet 22 and outlet (not shown) respectively disposed at the front and back sides for the passing of the object to be laminated, and an inside accommodating chamber for accommodating a feed roller, a sheet-transferring roller, a heating member and other related parts (not shown). Further, the housing 20 has two top recessed bearing portions 24 symmetrically disposed at the top side near the two distal ends, and an elongated sliding groove 26 formed in the top side and extending along the length.

The rail 30 is molded from flexible plastics and fastened with the two distal ends thereof to the top recessed bearing portions 24 of the housing 20, thereby defining with the housing 20 a narrow elongated gap 32 for the passing of the laminated. Further, the rail 30 has an elongated sliding slot 34 corresponding to the elongated sliding groove 26.

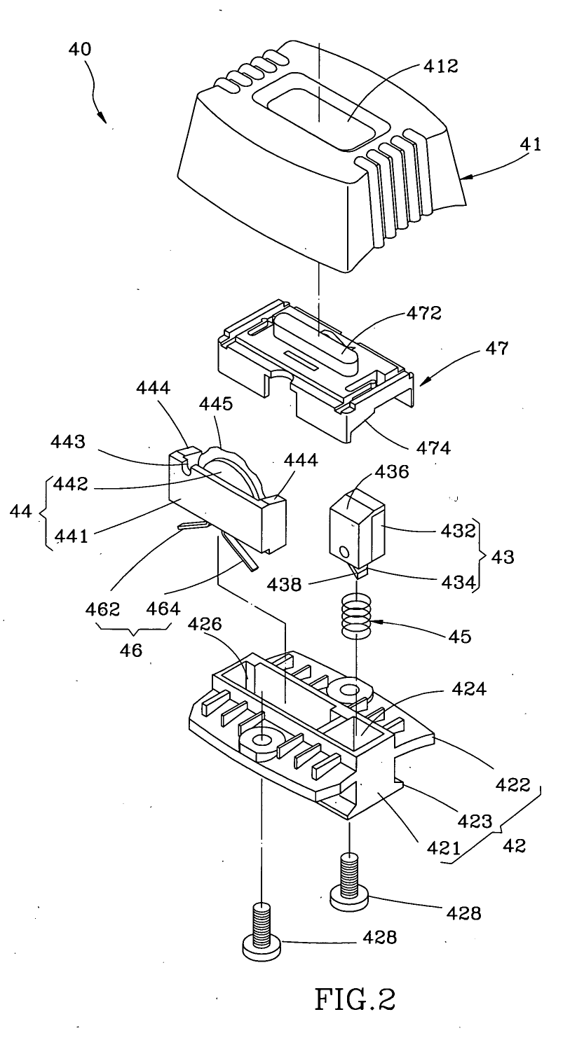

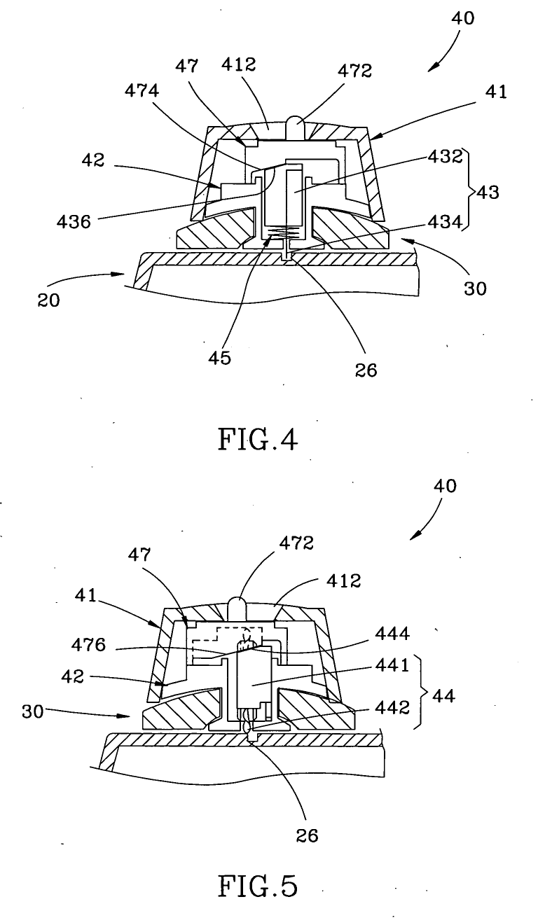

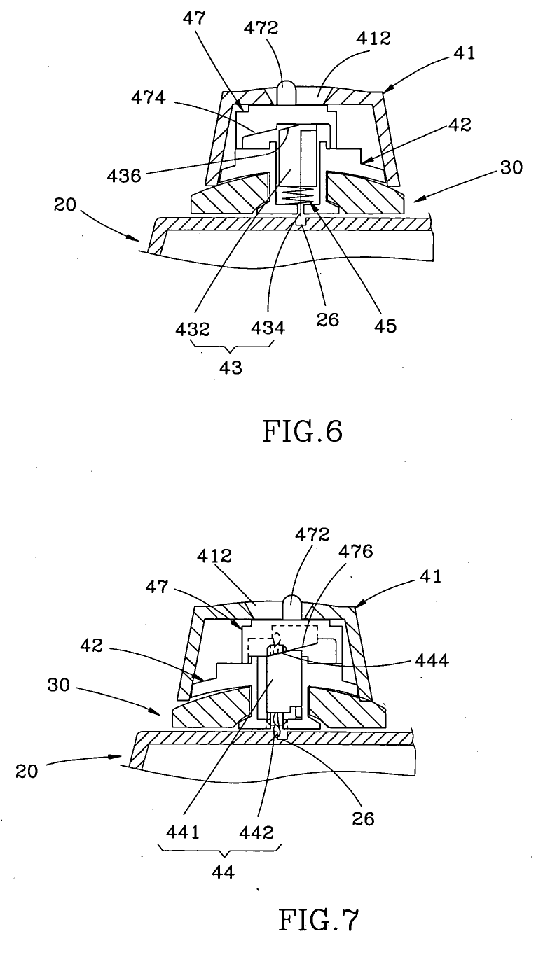

Referring to FIGS. 5-7 and FIGS. 2-4 again, the cutter assembly 40 comprises a casing composed of a cover 41 and a carrier block 42, a first cutter 43, a second cutter 44, a first spring member 45, a second spring member 46, and an operating member 47. The cover 41 has a top opening 412. The carrier block 42 has a body 421 inserted into the elongated sliding slot 34 of the rail 30, two top wings 422 and two bottom wings 423 respectively extending from the two opposite lateral sides of the body 421 at different elevations and respectively disposed in contact with the top and bottom walls of the rail 30 to guide movement of the carrier block 42 along the rail 30, a first top chamber 424 and a second top chamber 426 respectively formed in the body 421 at the top, a first bottom opening 425 formed in the bottom side of the body 421 in communication with the first top chamber 424, and a second bottom opening 427 formed in the bottom side of the body 421 in communication with the second chamber 426. During assembly process, the cover 41 is covered on the carrier block 42 and fixedly secured to the top wings 422 with screws 428 for movement with the carrier block 42 along the rail 30. The first cutter 43 comprises a cutter holder block 432 and a cutter blade 434. The cutter holder block 432 is vertically movably mounted in the first top chamber 424 of the body 421 of the carrier block 42, having a beveled top cut face 436. The cutter blade 43 is fixedly fastened to the bottom side of the cutter holder block 432, having a cutting edge 438 extending out of the first bottom opening 425. The second cutter 44 comprises a cutter holder block 441 and a roller cutter blade 442. The cutter holder block 441 is a U-shaped frame vertically movably mounted in the second top chamber 426 of the carrier block 42, having a receiving open space 443 cut through the top and bottom sides, two beveled stop faces 444 disposed at the top at two sides relative to the receiving open space 443. The beveled stop faces 444 slope in one direction reversed to the sloping direction of the beveled cut face 436 of the cutter holder block 432 of the first cutter 43. The roller cutter blade 442 is pivotally mounted in the receiving open space 443 of the cutter holder block 441 and partially extending out of the second bottom opening 427 of the carrier block 42. The peripheral edge of the roller cutter blade 442 is sharpened and corrugated, forming a cutting edge 445. The first spring member 45 is a compression spring sleeved onto the cutter blade 434 of the first cutter 43 and stopped between the bottom side of the cutter holder block 432 and the inside bottom wall of the first top chamber 424 to hold the first cutter 43 in a received position (see FIG. 6). The second spring member 46 comprises two spring strips 462 and 464. The spring strips 462 and 464 each have a top end fastened to the bottom side of the cutter holder block 441 and the other end respectively sloping downwards in a reversed direction and respectively stopped against the inside bottom wall of the second top chamber 426 to hold the second cutter 44 in a received position (see FIG. 5). The operating member 47 is mounted inside the cover 41 over the top side of the first cutter 43 and the second cutter 44, and movable relative to the cover 41 between a first position (see FIGS. 4 and 5) and a second position (see FIGS. 6 and 7). The operating member 47 has a top finger block 472 extending out of the top opening 412 of the cover 41, a first press portion 474 corresponding to the beveled cut face 436 of the first cutter 43, and a second press portion 476 corresponding to the beveled stop faces 444 of the second cutter 44. The first press portion 474 is beveled and matching the beveled cut face 436. When shifted the operating member 47 to the first position, the first press portion 474 is pressed on the beveled cut face 436, thereby forcing the first cutter 43 to extend out of the bottom side of the carrier block 42, as shown in FIG. 4. The second press portion 476 matches the beveled stop faces 444 of the second cutter 44. When shifted the operating member 47 to the second position, the second press portion 476 is pressed on the beveled stop faces 444, thereby forcing the second cutter 44 to extend out of the bottom side of the carrier block 42, as shown in FIG. 7.

After a laminating operation, the laminated object (for example, photo) is inserted into the narrow elongated gap 32 between the rail 30 and the housing 20, and then the cutter assembly 40 is operated to cut the edge of the laminated object. During cutting, the user can select to use the first cutter 43 or the second cutter 44 to cut the peripheral edge of the laminated object. The first cutter 43 is adapted to provide a straight cutting edge. The second cutter 44 is adapted to provide a corrugated cutting edge.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A laminating machine comprising:
a housing;
a rail mounted on said housing and defining with said housing a narrow elongated gap for the insertion of an object; and
a cutter assembly coupled to and movable along said rail for cutting an object being inserted into said narrow elongated gap.

2. The laminating machine as claimed in claim 1, wherein said housing comprises two recessed bearing portions bilaterally disposed at a top side thereof for supporting said rail.

3. The laminating machine as claimed in claim 1, wherein said rail comprises a longitudinal sliding slot; said cutter assembly comprises a carrier block slidably coupled to said longitudinal sliding slot of said rail.

4. The laminating machine as claimed in claim 1, wherein said cutter assembly comprises a casing slidably coupled to said rail and provided with a first chamber and a second chamber, a first cutter mounted in said first chamber and movable between a received position where said first cutter is kept inside said casing and an extended position where said first cutter extends partially out of said casing into said narrow elongated gap for cutting, a second cutter mounted in said second chamber and movable between a received position where said second cutter is kept inside said casing and an extended position where said second cutter extends partially out of said casing into said narrow elongated gap for cutting, and an operating member mounted movably in said casing for selectively touching said first cutter or said second cutter to move said first cutter or said second cutter to the respective extended position.

5. The laminating machine as claimed in claim 4, wherein said housing has a longitudinal sliding groove in a top side thereof corresponding to the longitudinal sliding slot of said rail for receiving one of said first cutter and said second cutter when one of said first cutter and said second cutter is held in the respective extended position.

6. The laminating machine as claimed in claim 4, wherein said casing of said cutter assembly has a top opening; said operating member has a finger block extending out of the top opening of said casing for operation by the user, and is movable between a first position where said operating member moves said first cutter to the extended position, and a second position where said operating member moves said second cutter to the extended position.

7. The laminating machine as claimed in claim 4, wherein said cutter assembly further comprises a first spring member mounted in said first chamber for supporting said first cutter in the received position.

8. The laminating machine as claimed in claim 4, wherein said casing of said cutter assembly has a first bottom opening in communication with said first chamber for letting said first cutter move to the extended position.

9. The laminating machine as claimed in claim 4, wherein said cutter assembly further comprises a second spring member mounted in said second chamber for supporting said second cutter in the received position.

10. The laminating machine as claimed in claim 9, wherein said second spring member comprises a plurality of strips respectively obliquely connected between said second cutter and an inside bottom wall of said second chamber.

11. The laminating machine as claimed in claim 4, wherein said casing of said cutter assembly has a bottom opening in communication with said second chamber for letting said second cutter move to the extended position; said second cutter comprises a roller cutter blade having a corrugated peripheral cutting edge.
